(19) United States
(12) Patent Application Publication
(10) Pub. No.: US 2006/0274672 A1
(43) Pub. Date: Dec. 7, 2006

(54) System and method for reducing unnecessary traffic in a network

(76) Inventors: Narayanan Venkitaraman, Schaumburg, IL (US); Madjid F. Nakhijiri, Palatine, IL (US); Vidya Narayanan, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/146,384

(22) Filed: Jun. 6, 2005

(51) Int. Cl. H04L 12/28; H04J 3/18

(52) U.S. Cl. 370/254; 370/477

(57) ABSTRACT

Connectivity status information of a mobile network node (104) that may connect to the mobile router (106) is tracked and determined. When the connectivity status of the mobile network node (104) indicates that the mobile network node (104) is no longer reachable, packets destined to be sent to that mobile network node (104) are intercepted.

### FIELD OF THE INVENTION

The field of the invention relates to routing communications through networks and, more specifically, to reducing unnecessary data traffic to components of a network.

### BACKGROUND OF THE INVENTION

The Mobile Internet Protocol (MIP) represents a network-level approach for supporting the mobility of mobile nodes and mobile routers across various networks and/or sub-networks. A node attached to the mobile router is known as a mobile network node (MNN). A mobile router may transparently provide mobility for an entire network known as a mobile network. Specifically, mobile routers enable mobile network nodes to maintain connectivity with a network or sub-network and access resources within the infrastructure even as the mobile router roams between networks or sub-networks.

A mobile network node may operate in its home network (as a Local Fixed Node (LFN) or home mobile node (HMN)) or a foreign network (as a visiting mobile node (VMN)). When the mobile network node operates in a foreign network, a home agent associated with the mobile network node tunnels data packets destined for the mobile network node to a Care of Address (CoA) associated with the mobile network node.

In previous systems, mobile network nodes often lost connectivity with the network infrastructure, for example, when the mobile network node became connected to an autonomous mobile router that had no connectivity with the infrastructure. In another example, mobile network nodes sometimes were improperly powered down, resulting in the mobile network node losing connectivity with the network. In both these situations, packets destined for the mobile network node traversed across the network and reached the mobile router from which the MNN had last registered even though the mobile network node was unreachable. Once the packets reached the mobile router, they were typically discarded.

Other problems occurred depending upon whether the mobile network node was a visiting mobile node or home mobile node. In the case of a visiting mobile node, packets typically were sent to the mobile router until a MIP registration timer expired at the home agent or until the mobile network node later became connected and sent another MIP registration from its new network. In the case of a home mobile node, no registration timer usually existed. Consequently, packets destined for the mobile network node were always sent to the mobile router.

In all of the above-mentioned situations, packets were unnecessarily sent to the mobile router and this resulted in wasted wireless resources. In addition, unneeded processing necessarily occurred at various legs of the transmission path, such as at servers where encryption, decryption, and authentication occurred. The unneeded processing resulted in further delays and inefficiency in the network. In such a scenario, previous system often sent an Internet Control Message Protocol (ICMP) Host unreachable message to the correspondent node. However, the message is usually discarded by the correspondent node or filtered by firewalls due to security concerns such as lack of any association between the router and the correspondent node.

### BRIEF DESCRIPTION OF THE DRAWINGS

FIG. 1 is a block diagram of a system for reducing unnecessary traffic to components in a network according to the present invention;

FIG. 2 is a block diagram of another system for reducing unnecessary traffic to components in a network according to the present invention;

FIG. 3 is a flowchart of an approach for reducing unnecessary traffic sent to components of a network according to the present invention;

FIG. 4 is a flowchart of an approach for reducing unnecessary traffic sent to components of a network according to the present invention;

FIG. 5 is a state transition diagram showing one example of the operation of a MVPN server according to the present invention;

FIG. 6 is a state transition diagram showing one example of the operation of a mobility router according to the present invention; and

FIG. 7 is a block diagram of a mobile router according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method reduces unnecessary data traffic over the access links to a mobile router or to other network components. Packets that are to be sent unnecessarily to the mobile router are intercepted before they can be sent to a router or other network device. Consequently, system resources are not used for the unnecessary data transmissions and the efficiency of the network is substantially enhanced.

In many of these embodiments, connectivity status information of a mobile network node that may connect to the mobile router is determined and tracked. When the connectivity status of the mobile network node indicates that the mobile network node is no longer reachable, packets destined to be sent to that mobile network node are intercepted. The intercepting may include discarding the packets or caching the packets for later use. In the case where the packets are cached for later use, when the mobile network node again becomes reachable, the packets that have been cached may be downloaded to the mobile network node.

In some of these embodiments, reachability information concerning the mobile network node is exchanged between the mobile router and a home agent. For example, this information may include data that shows a lack of response to messages sent to the mobile network node, a lack of layer 2 (L2) connectivity, a lack of a current lease of at least one Internet Protocol (IP) address, a lack of updated information concerning a current IP address of the mobile network node, and a failed authentication corresponding to the mobile network node. Other examples of reachability information may also be exchanged.

In others of these embodiments, the connectivity status is monitored and it is determined when the connectivity status of a currently unreachable mobile network node again becomes reachable. In this case, packets destined for the mobile network node are forwarded to the now-reachable mobile network node. In another example, if packets have been cached, then these stored packets are forwarded to the mobile network node when it is determined that the mobile network node is again reachable.

Thus, approaches are provided that substantially reduce or eliminate unnecessary packets sent to routers and/or other devices in networks. These approaches are easy to implement and increase the performance of networks as unnecessary data traffic is minimized or eliminated.

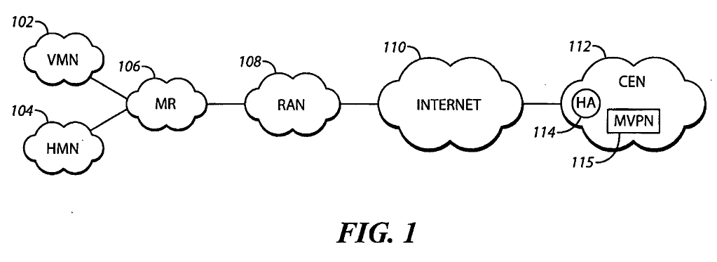

Referring now to FIG. 1, a system for minimizing unnecessary traffic to a mobile router 106 comprises a visiting mobile node (VMN) 102 and a home mobile node (HMN) 104 that are communicatively coupled to the mobile router 106. The HMN 104 has an associated home agent 114 that resides in a Customer Enterprise Network (CEN) 112. As shown, the HMN 104 is operating in its home mobile network with its home network (the CEN 112) having a home agent 114, while the VMN 102 is visiting from another sub-network and has a different home agent. The RAN 108 is connected to the CEN 112 via the Internet 110.

The VMN 102 and HMN 104 may be any type of mobile network node such as a cellular phone, pager, personal computer, network enabled web camera, or personal digital assistant. The CEN 112 is the home network of the mobile network. In other words, packets sent to the home address of the mobile router or an address in the mobile network sub-network, reach the home network. When the mobile router 106 or HMN 104 move to a foreign network, the HA 114 tunnels packets destined to the mobile router 106 or the HMN 104 using a Care of Address (CoA).

The mobile router 106 is coupled to a radio access network (RAN) 108. The RAN 108 includes equipment such as base stations, receivers, transmitters, and switches that allow the VMN 102 and HMN 104 to communicate with the CEN 112 and the HA 114. In addition, multiple RANs may exist and a mobile router could be connected simultaneously via one or more RAN.

In one example of the operation of the system of FIG. 1, different entities within the system may intercept packets. For instance, the HA 114 may intercept packets that are bound for the HMN 104 or VMN 102 via the router 106. In this case, the router 106 tracks the connectivity status of the HMN 104 and VMN 102 since these devices have been using the router 106 and are still connected to the router 106. The tracking can be initiated and accomplished by neighbor discovery algorithms such as those provided by Address Resolution Protocol (ARP) messaging. When the router 106 determines that a mobile network node that has been connected to the router 106 is not connected anymore (or when the router 106 receives a packet destined for a mobile network node that is not connected to the router 106), the router 106 sends a message to the home agent 114 in the CEN 112 to intercept the packets destined for that mobile network node. Messages may be sent immediately or after a delay and the mobile router 106 may use rate control and/or piggy backing to limit the number of control messages exchanged between the mobile router and home agent. Further, the messages may be sent directly to the device performing the interception. In addition, the message may specify a certain action be taken with the packets, such as discarding the packets or caching the packets for later use.

The actual intercepting may be performed at a variety of devices. For example, a Mobile Virtual Private Network (MVPN) server 115 may receive the interception request and, in response, add an entry in a Security Policy Database (SPD) that indicates that all packets having a specified IP address (of a mobile network node) are to be intercepted. Other devices may also be used to perform the intercepting. In another example, a node in the RAN may perform the interception. In still another approach, multiple entities may be configured to simultaneously perform the interception.

When the mobile network node becomes reconnected and sends a registration message from its current network, the intercepting at the CEN 112 may be halted. For example, if a SPD is used to indicate IP addresses to intercept, the SPD entry corresponding to the mobile network node may be removed. As a consequence, packets will again start flowing to the appropriate mobile router and mobile network node.

In another example of the operation of the system of FIG. 1, the router 106 may intercept packets that are bound from the router 106 to the HA 114 and from the HA 114 to a mobile network node presently in another network or sub-network. In this case, the router 106 exchanges information with the HA 114 and this information indicates that a mobile network node is no longer connected in another network. Consequently, packets that are to pass from the router 106 to the HA 114 (that are to be sent to a CoA of a mobile network node) are discarded at the router 106 rather than being sent on to the HA 114. The intercepting at the router 106 may result in the packets being discarded or cached at the router 106 for later use. When the mobile network node in the other network becomes reconnected in another network and sends a registration message from the other network, the intercepting may be halted.

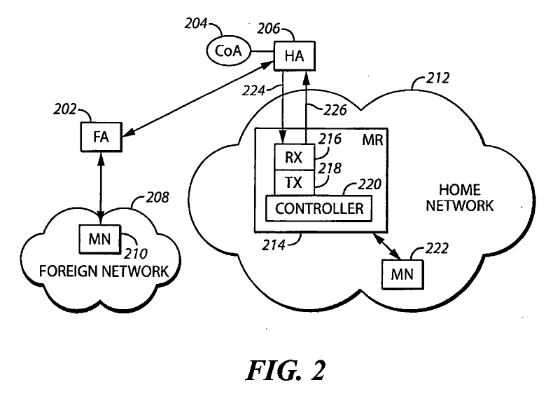

Referring now to FIG. 2, another example of a system for reducing unnecessary packet traffic to routers or other network devices is described. A home agent 206 is coupled to a mobile router 214, which is located within a home network 212. The mobile router 214 includes a receiver 216, a transmitter 218, and a controller 220. A mobile network node 222 is located within the home network 212.

A foreign network 208 includes a mobile network node 210 that may have been once in its home network 212. The mobile network node 210 can be accessed by using a care of address (CoA) 204, which contains addressing information pointing to a foreign agent 202 that can be used to communicate with the mobile network node 210.

The controller 220 is programmed to determine and track the connectivity status of the mobile network node 222 that is associated with the mobile router 214 based upon information received at the input of the receiver 216. The controller 220 is further programmed when the connectivity status of the mobile network node 222 changes (for example, when it becomes disconnected) to responsively send a message to the home agent 206 of the mobile network node 222 via the transmitter 218. The message informs the home agent 206 about the connectivity status of the mobile network node 222. The home agent 206 intercepts messages bound for the mobile network node 222 via a forward tunnel 224. This message may be sent directly to the Home Agent or may be sent indirectly via a different entity such as a foreign agent. Thus, unnecessary messages are not sent to the router 214 and the mobile network node 222 via the forward tunnel 224 saving system resources and bandwidth.

In another example of the operation of FIG. 2, the controller 220 of the mobile router 214 is programmed to learn when the mobile network node 210 becomes disconnected. This information can be conveyed from the home agent 206 when the home agent 206 learns that the mobile network node 210 is no longer reachable. The mobile router 214 then intercepts message from entities within the network 212 that are destined for the mobile network node 210 over a reverse tunnel 226. Thus, unnecessary messages are not sent to the home agent via the reverse tunnel 226, thereby saving system resources and bandwidth.

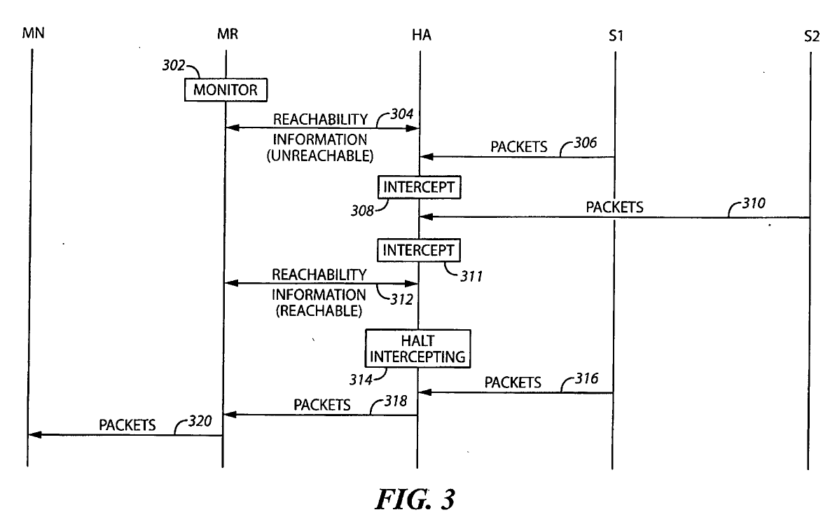

Referring now to FIG. 3, one example of an approach for intercepting packets is described. In the example of FIG. 3, a home agent is connected to a mobile router. At step 302, the mobile router monitors the connectivity status of a mobile network node that was associated with the router. At step 304, reachability information (indicating the connectivity status of a mobile network node) is exchanged between the router and the home agent. In this case, the reachability information indicates that the mobile network node is currently unreachable.

At step 306, a first packet source attempts to send packets to the mobile network node. The packet source may be another mobile network node, a network service, or any entity that may desire to send packets to the mobile network node. At step 308, the packets are intercepted by the home agent. In one example, the packets are discarded and in another example the packets are cached for later use. In the case of the interception being done at the MVPN server, a Security Policy Database (SPD) at the MVPN server may include an entry that indicates that packets destined for a particular IP address (e.g., the address of the mobile agent or the router) are to be intercepted. At step 310, packets from a second packet source are sent and, at step 311, these packets are intercepted at the home agent. If the source is another home agent, the node performing the interception may send reachability information to the other home agent to start intercepting packets. For example, when a VPN's packets are tunneled by the home agent of the VMN to the home agent of the mobile router, if the home agent of the mobile router has information indicating the VMN is no longer with its mobile router, the home agent of the mobile router may inform the home agent of the VMN to stop forwarding packets to the mobile router.

At step 312, reachability information is exchanged between the mobile router and the home agent. This reachability information indicates that the mobile network node is now reachable. For example, this information may be based upon and include data that show recent transmission of an ARP or neighbor advertisement message from the mobile network node or the presence of L2 connectivity. Other examples of reachability information may also be exchanged.

In response, at step 314, the home agent halts the intercepting of the packets destined for the mobile network node. For instance, if a SPD were used, the entry in the SPD that causes the intercepting may be removed. At step 316, the first packet source sends packets to the mobile network node. The packets arrive at the home agent but are not intercepted because the intercepting has been deactivated at the home agent. At step 318, the packets are forwarded to the mobile router. At step 320, the packets are sent from the mobile router to the mobile network node.

If caching was used during the interception process, then the packets may be stored in a memory and when the intercepting is deactivated, the packets may be sent on to the mobile network node. In this example, if caching were used, then packets are stored during the intercepting steps 308 and 311. Then, after intercepting is halted at step 314, the packets may be sent on to the mobile network node.

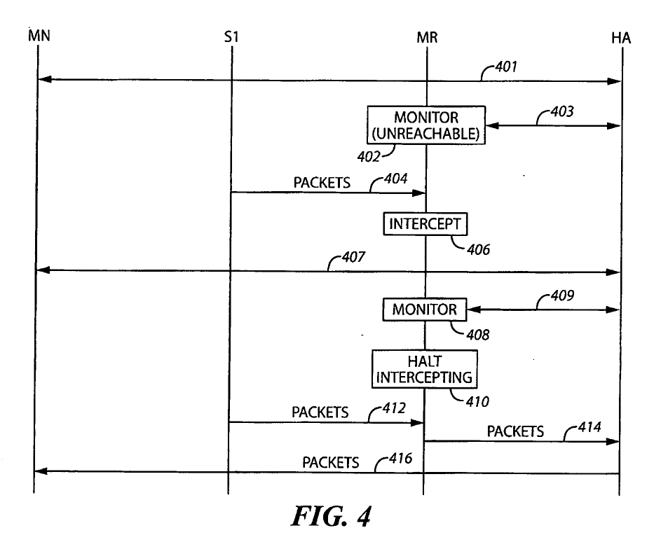

Referring now to FIG. 4, another example of intercepting packets to reduce unneeded packet flow to a mobile router or other network devices is described. At step 402, a mobile router monitors a mobile network node in a foreign network. The mobile network node was originally in its home network (with an associated home agent), but subsequently has moved to the foreign network. The mobile router determines that the mobile network node is unreachable. This may be determined from a lack of a registration request from the mobile network node and the home agent at step 401 and the home agent and the mobile router at step 403. If the node is unreachable, it is determined that the mobile router should intercept packets originating from its home network that are destined for the mobile network node that is now in the foreign network.

At step 404, packets are sent from a packet source somewhere in the home mobile network to the mobile node. For routing purposes, the packets may include the IP address of the mobile node. At step 406, the mobile router intercepts these packets. For example, the router may determine from a list of addresses-to-intercept that the address of the mobile network node is on the list and, consequently, intercepts the packets destined for that address.

At step 408, the mobile router may monitor the connectivity status of the mobile network node. This may be accomplished by forwarding connectivity status information from the mobile network node to the home agent at step 407 and from the home agent to the mobile router at step 409. In the example of FIG. 4, the connectivity information indicates that the mobile network node is again connected to its home agent (via a foreign agent and using a CoA) and, at step 410, the mobile router halts the intercepting of the packets. For example, if the IP address of the mobile network node were in a table of addresses-to-intercept, then that address may be removed from the table.

At step 412, packets are sent from the packet source to the mobile router and are destined for the mobile network node in the foreign network. Since the mobile network node is now reachable, the packets are forwarded from the mobile router to the home agent at step 414. At step 416, the packets are then forwarded from the home agent to the mobile network node, for instance, via a foreign agent using a CoA.

The mobility router and the MVPN server share information (using mobile node-connected and mobile node-disconnected messages) regarding the reachability of the mobile node. If the mobile node is connected to the home mobility router, then the mobility router will be able to track its reachability. Similarly, if the mobile node is away from home but is still communicable, then the MVPN server will have the CoA and therefore track its reachability. If these conditions are not met, then the MVPN server filters packets destined to mobile node over its forward tunnel and mobility router filters packets destined to mobile node over reverse tunnel.

The MVPN server tracks the state of each mobile node. Unlike previous MIP home agents, which track the CoA of a mobile and are oblivious to whether a mobile node is reachable at home or simply unreachable, the MVPN server can distinguish between a mobile node that is connected to its home subnet and a mobile node that is not reachable (either because it is powered off or is in autonomous mode).

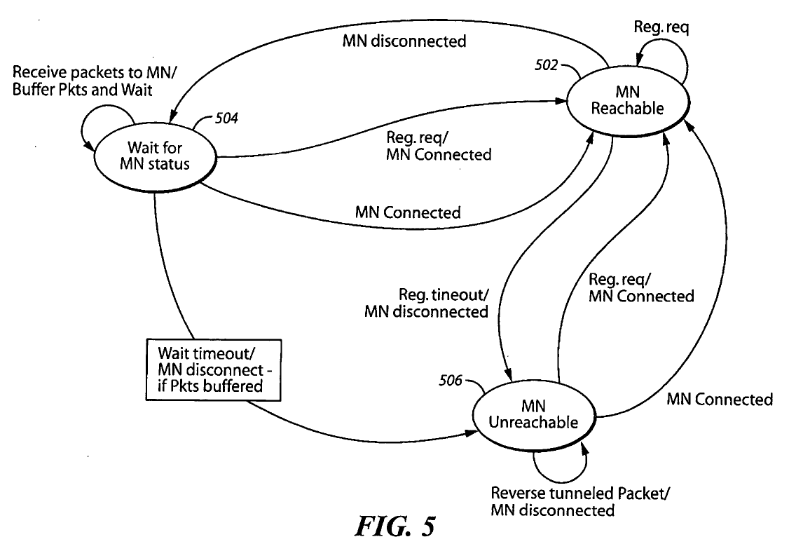

Referring now to FIG. 5, an example state diagram showing the different states of the MVPN server corresponding to each mobile node is described. The transitions are shown in the form A/B, where A corresponds to the trigger for the transition and B corresponds to the action or message that is generated as a result of the trigger.

An MN reachable state 502 exists where the MVPN server typically proxies for the mobile node and receives packets destined to a mobile node and forwards it to the mobile node. The packets may be forwarded by tunneling the packets either to the home mobility router or the CoA of mobile node based on connectivity of the mobile node. If the MVPN server determines that the mobile node is in the same link then MVPN server does not proxy for the mobile node.

The triggers to transition out of the state 502 are the registration of a MN times out, and when the MVPN server receives a “MN disconnected” message. The first trigger happens when a mobile node that was in a foreign network and registered with a MVPN Server becomes disconnected. When this happens, the MVPN server directly moves to a mobile node unreachable state 506 and informs the mobility router. This message would then trigger that mobility router to halt reverse tunneling packets destined to the now unreachable mobile node.

The second trigger occurs when a (home or visiting) mobile node that was connected to a mobility router leaves. The mobility router may detect this by a variety of approaches, for example, by detecting a Layer 2 (L2) trigger on connection loss, DHCP lease timeout, or lack of response to ARP. The “MN disconnected” message is typically sent from a mobility router to the MVPN server serving a mobility router corresponding to an IP address in the mobility router subnet. For a visiting mobile node (VMN), a mobility router may generate this message if it keeps receiving packets to a VMN that is no longer connected to it (i.e., the VMN did not register a new address with its home MVPN Server). Furthermore, a MVPN server may send this message to another MVPN server (i.e., a MVPN server of the VMN may receive this from the MVPN server of the mobility router that the mobile node was last registered). Preferably, this message is authenticated. While sending this message, well know rate control schemes may be used to restrict the number of such messages that are generated.

In the latter case, the MVPN server moves into a Wait for MN Status state 504, which is an intermediate state. Moving to this state accommodates cases where a mobile node leaves a mobility router and its registration is delayed due to the time required to authenticate with new network and acquire a CoA. Meanwhile, the old mobility router or its MVPN server may send “MN disconnected” message.

The triggers to come into the state 504 include the mobile node sending a registration request from a foreign network and the MVPN server receiving a MR-connected message. In the first case, a mobile node moves to a foreign network and/or the mobility router that it is connected to moved from autonomous to connected mode. When this happens, the MVPN server directly moves to the MN reachable state 502. It also informs the “home” mobility router. This message would then trigger that mobility router to start reverse tunneling packets destined to the now reachable mobile node.

In the second case, the home mobile node or visiting mobile node moves into or powers up at a mobility router. The mobility router then sends a message to its MVPN server, indicating that a MN/IP address is active. The mobility router may skip this step for a home mobile node, if the home mobile node generates a deregistration request to the MVPN server.

As mentioned, the Wait for MN Status state 504 is an intermediate state in which the MVPN server is trying to determine the real state of the mobile node. The only trigger to come into this state is a “MN disconnected” message. As this message may be received by the MVPN server before a mobile node obtains a CoA in foreign network and registers it, in this state the MVPN server preferably buffers packets that it receives on behalf the mobile node (from the network or reverse tunneled from mobility routers). Preferably, a pre-defined timeout value exists after which the status automatically changes to “MN unreachable” if the status of the mobile node is not otherwise confirmed as being reachable via either a registration request from the mobile node or a mobile node connected message from its home mobility router.

In the MN Unreachable state 506, the MVPN server preferably drops packets. The triggers to enter the state 506 are occur when an existing registration from a mobile node times out or when a timeout occurs in the Wait for MN status state 504. In the former case, the MVPN server preferably informs the mobility router using a MN disconnected message. This message may then be used by the mobility router to stop reverse tunneling packets destined to the mobile node to the MVPN server.

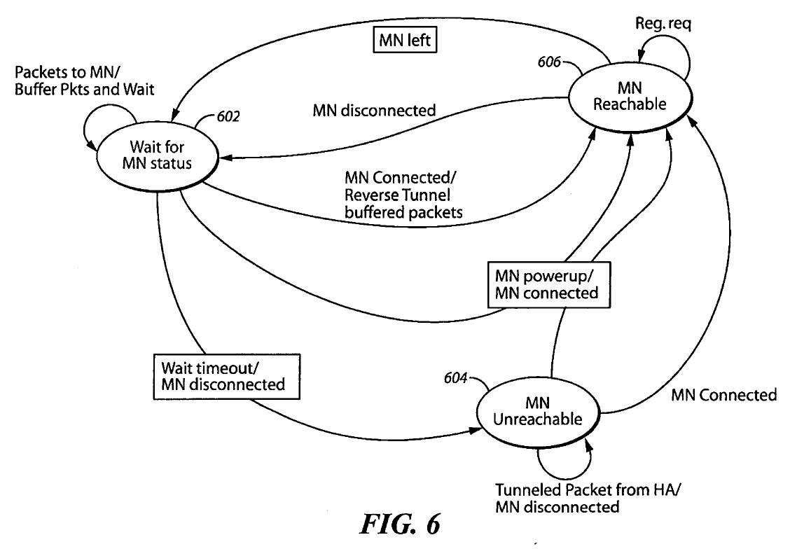

Referring now to FIG. 6, an example of the operation and states of a mobility router is described. A Wait for MN Status state 602 exists where the mobility router moves when it is trying to determine the real state of the mobile node. The triggers to transition into this state are when a mobility router realizes that the mobile node is no longer connected to its mobile network and when the mobility router receives a MN disconnected message from its MVPN server. The first trigger may be accomplished by using a combination of approaches such as snooping ARP messages, using L2 triggers, sending keep alive messages, or sending DHCP messages. In the state 502 the mobility router preferably buffers packets that are destined to the mobile node, but preferably does not reverse tunnel the packets.

A MN Unreachable state 604 also exists. The mobility router moves into this state only when it times out in the Wait for MN Status state 602. In this state, the mobility router preferably does not reverse tunnel packets destined to mobile node.

A MN Reachable state 606 also exists. In this state, the mobility router distinguishes between whether the mobile node is a “home mobile subnet” or “away”. In the former case, the mobility router allows direct communication between local mobile nodes in the mobile subnet. In the latter case, the mobility router reverse tunnels packets to the MVPN server.

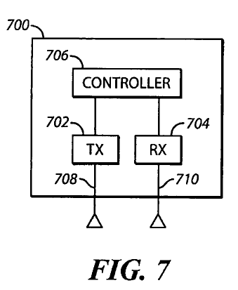

Referring now to FIG. 7, one example of a mobility agent 700 is described. The mobility agent 700 includes a transmitter 702 (having an output 708), receiver 704 (having an input 710), and controller 706. The controller 706 is programmed to determine and track a connectivity status of a mobile network node that is associated with the mobility agent 700 based upon information received at the input 710 of the receiver 704. The controller 706 is further programmed to, when the connectivity status of the mobile network node changes, responsively send a message to a home agent of the mobile network node via the output 708 of the transmitter 702. The message informs the home agent about the connectivity status of the mobile network node.

In one example, the controller 706 is further programmed to intercept packets to be sent from the mobility agent 700 to the mobile network node via a reverse tunnel to the home agent when the connectivity status indicates the mobile network node is unreachable. The controller 706 may also be programmed to intercept packets by caching at least some of the packets in a memory device, or, alternatively intercept packets by discarding at least some of the packets. In another example, the controller 706 may be further programmed to determine when the connectivity status information indicates that the mobile network node is reconnected to the mobility agent 700 and, responsively, to stop interception and transmit a status update indicating the reconnection of the mobile network node to the home agent.

Thus, approaches are provided that substantially reduce or eliminate unnecessary packets sent to routers and/or other devices in networks. These approaches enhance the performance of networks as unnecessary data traffic is minimized or eliminated.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for reducing unnecessary packet traffic over access links of a mobile router comprising:
determining and tracking a connectivity status of a mobile network node that may connect to the mobile router; and
when the connectivity status of the mobile network node indicates that the mobile network node is no longer reachable, responsively intercepting packets destined to be sent to the mobile network node.

2. The method of claim 1 wherein determining and tracking the connectivity status comprises exchanging reachability information about the mobile network node between the mobile router and a home agent.

3. The method of claim 2 wherein the step of exchanging the reachability information comprises exchanging sub-network information.

4. The method of claim 1 wherein determining and tracking the connectivity status comprises identifying information selected from a group consisting of a lack of response to messages sent to the mobile network node; a lack of layer 2 (L2) connectivity; a lack of a current lease of at least one IP address; a lack of updated information concerning a current IP address of the mobile network node; and a failed authentication corresponding to the mobile network node.

5. The method of claim 1 further comprising determining when the connectivity status of the mobile network node becomes reachable and, responsively, halting the intercepting.

6. The method of claim 1 wherein determining and tracking the connectivity status of the mobile network node comprises determining and tracking the connectivity status of a mobile network node selected from a group comprising a home mobile network node, a visiting mobile network node, a fixed node, and a mobile router.

7. The method of claim 1 further comprising, responsive to determining the mobile network node is not reachable, intercepting the packets destined for the mobile network node from at least one location selected from a group comprising the home agent and the mobile router.

8. The method of claim 7 wherein intercepting the packets comprises discarding at least some of the packets.

9. The method of claim 7, wherein intercepting the packets comprises caching at least some of the packets in a memory device.

10. The method of claim 9 further comprising transmitting the cached packets when the mobile network node becomes reachable.

11. A method for reducing unnecessary traffic in a network comprising a network mobility agent comprising:
determining and tracking a connectivity status of a mobile network node when the network node is in a home network associated with the network node and when the mobile network node is unreachable.

12. The method of claim 11 further comprising determining and tracking the connectivity status of the mobile network node when the node becomes connected to a foreign network.

13. The method of claim 11 further comprising, when the connectivity status of the mobile network node changes, responsively sending a message to the home mobile router of the mobile network node, the message informing the mobile router about the connectivity status of the mobile network node.

14. The method of claim 11 further comprising when the status of the mobile network node indicates that the node is not reachable, responsively intercepting packets destined for the mobile network node.

15. The method of claim 14 further comprising when the connectivity status indicates the mobile network node has become reachable, halting the intercepting.

16. A mobility agent comprising:
a receiver having an input;
a transmitter having an output; and
a controller coupled to the receiver and transmitter, the controller programmed to determine and track a connectivity status of a mobile network node that is associated with the mobility agent based upon information received at the input of the receiver; and wherein the controller is further programmed to, when the connectivity status of the mobile network node changes, responsively send a message to a home agent of the mobile network node via the transmitter output, the message informing the home agent about the connectivity status of the mobile network node.

17. The mobility agent of claim 16 wherein the controller is further programmed to determine when the connectivity status information indicates that the mobile network node is reconnected to the mobility agent and, responsively, to stop interception and transmit a status update indicating the reconnection of the mobile network node to the home agent.

18. The mobility agent of claim 16 wherein the controller is further programmed to intercept packets to be sent from the mobility agent to the mobile network node via a reverse tunnel to the home agent when the connectivity status indicates the mobile network node is unreachable.

19. The mobility agent of claim 18 wherein the controller is programmed to intercept packets by caching at least some of the packets in a memory device.

20. The mobility agent of claim 18 wherein the controller is programmed to intercept packets by discarding at least some of the packets.
